(19) United States
(12) Patent Application Publication
(10) Pub. No.: US 2026/0317668 A1
(43) Pub. Date: Oct. 15, 2026

(54) BEER WITH IMPROVED FLAVOUR STABILITY

(71) Applicant: Heineken Supply Chain B.V., Zoeterwoude (NL)

(72) Inventor: Deborah Casandra Gernat, Zoeterwoude (NL)

(73) Assignee: Heineken Supply Chain B.V., Zoeterwoude (NL)

(21) Appl. No.: 19/485,290

(22) PCT Filed: May 22, 2024
(86) PCT No.: PCT/EP2024/064128

§ 371 Date: Nov. 18, 2025

(30) Foreign Application Priority Data
May 26, 2023 (EP) 23175823.6

(51) Int. Cl. C12H 1/044; B01J 20/18; B01J 20/28; C12C 11/00

(52) U.S. Cl. CPC C12H 1/0408; B01J 20/18; B01J 20/28061; B01J 20/28064; B01J 20/28066; C12C 11/003

(57) ABSTRACT

The invention relates to an alcoholic beer having an ethanol content of at least 1% ABV, and containing 9(S),12(S),13(S)-trihydroxy-10(E)-octadecenoic acid (TOA) and free amino nitrogen (FAN) in ratio of less than 0.035 mg of TOA per mg of FAN.

The inventors have discovered that the staling of alcoholic beer during storage can be slowed down by selectively removing 9(S),12(S),13(S)-trihydroxy-10(E)-octadecenoic acid (TOA) from the wort prior to fermentation.

Another aspect of the invention relates to a method of preparing a beer, said method comprising the following successive steps:
providing a wort;
contacting the wort with ZSM-5 zeolite;
separating the treated wort from the ZSM-5 zeolite;
fermenting the treated wort with yeast to produce fermented wort having an alcohol content of at least 1% ABV; and
separating yeast from the fermented wort.

### TECHNICAL FIELD OF THE INVENTION

The present invention relates to an alcoholic beer with improved flavour stability, especially a beer that is less prone to the formation of (E)-2-nonenal during storage. This beer is characterised by a reduced content of 9(S),12(S),13(S)-trihydroxy-10(E)-octadecenoic acid.

The invention also relates to a method of producing an alcoholic beer, said method comprising:
contacting wort with ZSM-5 zeolite;
separating the treated wort from the ZSM-5 zeolite;
fermenting the treated wort with yeast to produce fermented wort having an ethanol content of at least 1% ABV; and
separating yeast from the fermented wort.

The hydroxy fatty acid 9(S),12(S),13(S)-trihydroxy-10(E)-octadecenoic acid is selectively removed from the wort by the treatment with ZSM-5 zeolite.

### BACKGROUND OF THE INVENTION

During storage, beer undergoes a variety of chemical reactions, which lead to unavoidable flavour deterioration. Many of the resulting off-flavours are associated with the presence of the so-called staling aldehydes. Staling aldehydes may arise via de novo formation e.g. oxidation of unsaturated fatty acids, Strecker degradation of amino acids and Maillard reactions. Furthermore, aldehydes can be also released from their non-volatile bound-state forms e.g. cysteine or bisulphite adducts.

Beers contain trace amount of lipids. Autoxidation of the fatty acid linoleic acid gives rise to the formation of (E)-2-nonenal. This aldehyde contributes a cardboard flavour to stale beer and has a very low flavour threshold of 0.03 μg/L.

ZSM-5 is an aluminosilicate zeolite belonging to the pentasil family of zeolites. Its chemical formula is NaₙAlₙSi₉₆₋ₙO₁₉₂·16H₂O (0<n<27). ZSM-5 is composed of several pentasil units linked together by oxygen bridges to form pentasil chains. A pentasil unit consists of eight five-membered rings. In these rings, the vertices are Al or Si and an O is assumed to be bonded between the vertices. The pentasil chains are interconnected by oxygen bridges to form corrugated sheets with 10-ring holes. Like the pentasil units, each 10-ring hole has Al or Si as vertices with an O assumed to be bonded between each vertex. Each corrugated sheet is connected by oxygen bridges to form a structure with straight 10-ring channels running parallel to the corrugations and sinusoidal 10-ring channels perpendicular to the sheets. Adjacent layers of the sheets are related by an inversion point. The estimated pore size of the channel running parallel with the corrugations is 5.4-5.6 Å. The crystallographic unit cell of ZSM-5 has 96 T sites (Si or Al), 192 O sites, and a number of compensating cations depending on the Si/Al ratio, which ranges from 12 to infinity.

Hamberg (Trihydroxyoctadecenoic Acids in Beer: Qualitative and Quantitative Analysis, J. Agric. Food Chem. (1991), 39, 1568-1572) report that 9,10,13- and 9,12,13-trihydroxyoctadecenoic acids are present in beer and derived from linoleic acid. Although all of the 16 possible isomers were detected in beer, circa 60% of total 9,10,13- and 9,12,13-trihydroxyoctadecenoic acids was accounted for by a single isomer, i.e. 9(S),12(S),13(S)-trihydroxy-10(E)-octadecenoic acid.

JP 2010124748 describes a method for producing a fermented malt beverage which comprises the treatment of wort with activated charcoal to remove trans-2-nonenal.

WO 206/065557 describes a method for preventing or reducing off-flavor in a beverage comprising the steps of:
a. contacting a beverage with silica filter media whose surface active groups have been reacted with one or more silanes,
b. binding one or more off-flavor components to the silica filter media, and
c. separating the beverage from the silica filter media.

WO 2007/061602 describes a method for removing 2,4,6 Trichloroanisole from a beverage comprising contacting said beverage with a molecular sieve which is a Zeolite-Y (Faujasite) having a Si/Al ratio of at least 5.

WO 2018/213154 describes a method for modulating the flavour profile of a food comprising processing the food in the presence of one or more molecular sieves which remove all or a portion of one or more flavour compounds and one or more toxic compounds.

WO 2020/055233 describes a process of producing a non-alcoholic beer, wherein non-alcoholic beer is contacted with a hydrophobic silicate-based molecular sieve containing SiO₂ and Al₂O₃ in a molar ratio of at least 15.

De Rouck et al. (The impact of wort production on the flavour quality and stability of pale lager beer, BrewingScience January/February 2013 (Voi. 66), 1-11) describes a study in which the coarse milling-lautertun operations were compared with fine milling thinbed mash filter operations. A beer having an ethanol content of 5.49% (v/v) and a FAN content of 78.31 as well as a beer having an ethanol content of 5.3% (v/v) and a FAN content of 91.38 mg/L are described. Trihydroxy fatty acid contents of 3.17 and 3.07 mg/L are reported in Table 2 for the two worts that were used in the production of the aforementioned two beers.

Esterbauer et al. (Isomere Trihydroxy-octadecensauren in Bier: Beweise für ihr Vorkommen und ihre quantitative Bestimmung, Z. Lebensm. Unters.-Forsch. 164, 255-259 (1977)) describes a study in which commercial beers from the USA and Austria were analysed to determine the amount of isomeric trihydroxy octadecenoic acids present therein. Table 2 reports concentration levels for 9(S),12(S),13(S)-trihydroxy-10(E)-octadecenoic acid (G1) 468 μg/100 mL and 760 μg/100 mL, which equates to 4.68 mg/L and 7.60 mg/L, respectively.

### SUMMARY OF THE INVENTION

The inventors have discovered that the staling of alcoholic beer during storage can be slowed down by selectively removing 9(S),12(S),13(S)-trihydroxy-10(E)-octadecenoic acid (TOA) from the wort prior to fermentation.

Accordingly, one aspect of the invention relates to an alcoholic beer having a reduced TOA content, more particularly an alcoholic beer having an ethanol content of at least 1% ABV, and containing TOA and free amino nitrogen (FAN) in ratio of less than 0.035 mg of TOA per mg of FAN.

TOA is believed to be formed from linoleic acid during malting and mashing of barley and other cereals. Although the inventors do not wish to be bound by theory, it is believed that during storage of beer TOA is readily oxidised to from (E)-2-nonenal, thereby contributing to the staling of the beer.

Free Amino Nitrogen (Fan) is a measure of the concentration of individual amino acids and small peptides (one to three units). FAN is a degradation product of protein in raw materials such as malted barley and non-malted cereals.

Since both TOA and FAN originate from barley and/or other cereals, a low TOA/FAN ratio is indicative of the reduction of TOA.

Another aspect of the invention relates to a method of preparing a beer, said method comprising the following successive steps:
providing a wort having a gravity of 4.5 to 20° P;
contacting the wort with ZSM-5 zeolite for at least 15 minutes, said ZSM-5 zeolite having has a molar ratio SiO₂/Al₂O₃ of at least 1,000;
separating the treated wort from the ZSM-5 zeolite;
fermenting the treated wort with yeast to produce fermented wort having an alcohol content of at least 1% ABV; and
separating yeast from the fermented wort.

The treatment of wort with ZSM-5 zeolite significantly reduces the TOA content of the wort and the beer produced therefrom. Formation of (E)-2-nonenal during storage of the zeolite treated beer is also reduced.

### DETAILED DESCRIPTION OF THE INVENTION

A first aspect of the present invention relates to a beer having an ethanol content of at least 1% ABV, and containing 9(S),12(S),13(S)-trihydroxy-10(E)-octadecenoic acid (TOA) and free amino nitrogen (FAN) in ratio of less than 0.035 mg of TOA per mg of FAN.

The term “beer” as used herein refers to a yeast fermented malt beverage that has optionally been hopped. Beer is commonly produced by a process that comprises the following basic steps:
mashing a mixture comprising malted barley, optionally supplementary grains and water to produce a mash;
separating the mash in wort and spent grains;
boiling the wort to produce a boiled wort;
fermenting the boiled wort with live yeast to produce a fermented wort;
subjecting the fermented wort to one or more further process steps (e.g. maturation and filtration) to produce beer; and
packaging the beer in a sealed container, e.g. a bottle, can or keg.

The term “lager beer” as used herein refers to a beer which has been brewed and conditioned at temperatures below 15° C. The yeasts employed in the production of lager beers collect at the bottom of the fermenting beer and are therefore referred to as bottom-fermenting yeasts.

According to a particularly preferred embodiment, the beer of the present invention is a lager beer.

The free amino nitrogen (FAN) content of beer can suitably be determined by Analytica—EBC of the European Brewery Convention, Method 9.10.2 (Free amino nitrogen in Beer by discrete analyser (NOPA Method)—2017).

The beer of the present invention preferably contains TOA and FAN in a ratio of 0.005-0.033 mg of TOA per mg of FAN, more preferably in a ratio of 0.010-0.030 mg of TOA per mg of FAN.

The FAN content of the preferably is in the range of 40 to 200 mg/L, more preferably of 50-180 mg/L and most preferably of 60-140 mg/L.

Preferably, the TOA content of the beer is less than 5 mg/L, more preferably 0.5-4 mg/L, even more preferably 1.0-3.6 mg/L and most preferably 2.0-3.3 mg/L.

The beer preferably contains 0-0.05 μg/L of (E)-2-nonenal, more preferably 0.005-0.03 μg/L of (E)-2-nonenal and most preferably 0.008-0.02 μg/L of (E)-2-nonenal.

The beer preferably contains (E)-2-nonenal and FAN in a ratio of 00.1-1 μg of (E)-2-nonenal per mg of FAN, more preferably in a ratio of 0.02-5 μg of (E)-2-nonenal per mg of FAN, most preferably in a ratio 0.03-0.1 μg of (E)-2-nonenal per mg of FAN.

The benefits of the present invention are particularly pronounced in a beer that has been stored for a prolonged period of time. During storage of beer, the furfural content of the beer increases gradually. According to a preferred embodiment, the (stored) beer of the present invention contains 50-600 μg/L of furfural, more preferably 70-500 μg/L of furfural μg/L and most preferably 100-400 μg/L of furfural.

The (stored) beer preferably contains furfural and FAN in a ratio of 0.5-8 μg of furfural per mg of FAN, more preferably in a ratio of 1-6 μg of furfural per mg of FAN and most preferably more preferably in a ratio of 1.2-4 μg of furfural per mg of FAN.

The beer of the present invention differs from ordinary beers in that during storage the (E)-2-nonenal content increases at a relatively low rate in comparison to the rate at which furfural content increases. Accordingly, in a preferred embodiment, the (stored) beer contains (E)-2-nonenal and furfural are present in a weight ratio of less than 1:6,000, more preferably in weight ratio of 1:100,000 to 1:10,000 most preferably in a weight ratio of 1:60,000 to 1:12,000.

The ethanol content of the beer is preferably in the range of 2-8% ABV, more preferably in the range of 4-7% ABV and most preferably in the range of 4.5-6.5% ABV.

The beer preferably has a specific gravity at 20° C. in the range of 4.5 to 20, more preferably of 8 to 19 and most preferably of 14 to 18.

The beer of the present invention preferably does not comprise any adjuncts, i.e. it is a 100% cereal beer. Even more preferably, the is beer is a 100% malt beer. Most preferably, the beer is a 100% barley malt beer.

Another aspect of the invention relates to a method preparing a beer, said method comprising the following successive steps:
providing a wort having a gravity of 4.5 to 20° P;
contacting the wort with ZSM-5 zeolite for at least 15 minutes, said ZSM-5 zeolite having has a molar ratio SiO₂/Al₂O₃ of at least 1,000;
separating the treated wort from the ZSM-5 zeolite;
fermenting the treated wort with yeast to produce fermented wort having an alcohol content of at least 1% ABV; and
separating yeast from the fermented wort.

According to a particularly preferred embodiment, the present method yields a beer as described herein before.

The wort that is contacted with the ZSM-5 zeolite in the present method preferably has a gravity of 10 to 18° P, more preferably of 10 to 15° P.

Preferably, the wort is contacted with ZSM-5 zeolite by combining 1000 parts by weight of wort with at least 1 part by weight of ZSM-5 zeolite. More preferably, the wort is contacted with ZSM-5 zeolite by combining 1000 parts by weight of wort with 2-10 parts by weight of ZSM-5 zeolite.

The wort is preferably contacted with ZSM-5 zeolite for 30-300 minutes, more preferably for 40-240 minutes.

The wort preferably has a temperature in the range of 0 to 95° C., more preferably in the range of 2 to 50° C. when it is contacted with the zeolite.

The ZSM-5 zeolite that is employed in the present method preferably has a molar ratio SiO₂/Al₂O₃ of more than 2,000.

The surface area of the ZSM-5 zeolite preferably is at least 100 m²/g, more preferably 150 to 2,000 m²/g and most preferably 200 to 1,000 m²/g. The surface area of the hydrophobic molecular sieve can be determined by the BET method.

The wort may be contacted with the zeolite by mixing the zeolite and the wort. Alternatively, the wort may be contacted with the zeolite by passing the wort through a column that is filled with the zeolite.

In case the wort is contacted with zeolite by mixing the zeolite and the wort, the treated wort may be separated from the zeolite by, for instance, decanting, filtration or centrifugation. Preferably, the zeolite is treated wort is separated from the zeolite before it is fermented.

The treated wort is preferably fermented with a bottom-fermenting yeast.

Preferably, the treated wort is fermented at a temperature of 0 to 15° C., more preferably a temperature of 4 to 14° C. and most preferably a temperature of 7 to 12° C.

In the present method the treated wort is preferably fermented with yeast to produce fermented wort having an alcohol content of 2-12% ABV, more preferably in the range of 4-10% ABV and most preferably in the range of 4.5-7.5% ABV.

The invention is further illustrated by the following non-limiting examples.

### EXAMPLES

### Example 1

A lager beer (Reference) having an ethanol content of 5% ABV was produced as follows:
Trub was removed from a boiled hopped wort (gravity 16°) in a whirlpool;
The clarified wort was cooled and fermented for 15 days at 8° C.;
The fermented beer was filtered, conditioned and bottled.

### Example 2

A lager beer (Beer 1) was produced in the same way as the beer of Example 1, the only difference being that prior to fermentation the clarified wort was contacted with ZSM-5 zeolite as follows:
The clarified wort was cooled to 8.5° C.;
The zeolite was dosed in an amount of 10 g/L;
The combination of wort and zeolite was kept at 8.5° C. for 5 hours under stirring.
The zeolite was removed from the wort by means of filtration.

The powdered ZSM-zeolite used had the following characteristics:
MFI zeolite
Molar ratio SiO₂/Al₂O₃≥1,000
BET surface area: ~350 m²/g
Pore size: 5.6 Å (straight), 5.3 Å (sinusoidal)

### Example 3

The lager beers of Examples 1 and 2 were stored for 3 months at 30° C.

At the beginning of the storage period and after storage the beers were analysed. The results of the analyses are summarised in Table 1.

TABLE 1

| | Storage time (months) | | | |
|---|---|---|---|---|
| | Reference beer | | Beer 1 | |
| | 0 | 3 | 0 | 3 |
| 9(S),12(S),13(S)-trihydroxy-10(E)- | 6.9 | 5.9 | 3.0 | 2.6 |
| octadecenoic acid (TOA) in mg/L | | | | |
| Free amino nitrogen (FAN) in mg/ | 112 | 109 | 133 | 126 |
| L | | | | |
| (E)-2-nonenal in μg/L | 0.03 | 0.10 | 0.01 | 0.01 |
| Furfural in μg/L | 38 | 465 | 27 | 210 |
| TOA/FAN in mg/mg | 0.062 | 0.054 | 0.023 | 0.021 |

### Example 4

A number of commercially available lager beers were stored for 3 months at 30° C. At the beginning of the storage period and after storage the beers were analysed. The results of the analyses are summarised in Tables 2 and 3.

TABLE 2

| | Storage time (months) | | | | | | | |
|---|---|---|---|---|---|---|---|---|
| | Jupiler ® | | Corona ® | | Heineken ® | | Amstel ® | |
| | 0 | 3 | 0 | 3 | 0 | 3 | 0 | 3 |
| TOA in mg/L | 5.9 | 4.8 | 4.9 | 4.2 | 6.2 | 5.3 | 6.4 | 5.6 |
| FAN in mg/L | 67 | 63 | 54 | 54 | 91 | 90 | 106 | 104 |
| Furfural in μg/L | 188 | 538 | 261 | 687 | 20 | 214 | 21 | 214 |
| TOA/FAN in mg/mg | 0.088 | 0.076 | 0.091 | 0.078 | 0.068 | 0.059 | 0.060 | 0.054 |

TABLE 3

| | Storage time (months | | | | | |
|---|---|---|---|---|---|---|
| | Stella Artois ® | | Carlsberg ® | | Budweiser ® | |
| | 0 | 3 | 0 | 3 | 0 | 3 |
| TOA in mg/L | 4.7 | 4.0 | 5.1 | 4.5 | 6.2 | 5.1 |
| FAN in mg/L | 92 | 90 | 126 | 117 | 115 | 101 |
| Furfural in | 229 | 390 | 108 | 419 | 107 | 417 |
| μg/L | | | | | | |
| TOA/FAN in | 0.051 | 0.044 | 0.040 | 0.038 | 0.053 | 0.050 |
| mg/mg | | | | | | |

1. An alcoholic beer having an ethanol content of at least 1.0% ABV, and containing 9(S),12(S),13(S)-trihydroxy-10(E)-octadecenoic acid (TOA) and a free amino nitrogen (FAN) in ratio of less than 0.035 mg of TOA per mg of FAN.

2. Beer according to claim 1, wherein the beer has a FAN content of 40 to 200 mg/L.

3. Beer according to claim 1, wherein the beer has a TOA content of less than 5 mg/L.

4. Beer according to claim 1, wherein the beer contains 0-*0.05 μg/L of (E)-2-nonenal.

5. Beer according to claim 1, wherein the beer contains 50-600 μg/L of furfural.

6. Beer according to claim 1, wherein the beer contains (E)-2-nonenal and furfural in a weight ratio of less than 1:6,000.

7. Beer according to claim 1, wherein the beer has an ethanol content of 3-6% ABV.

8. Beer according to claim 1, wherein the beer has a specific gravity at 20° C. in the range of 4.5 to 20° P.

9. Beer according to claim 1, wherein the beer is a 100% cereal beer.

10. A method for preparing an alcoholic beer according to claim 1, said method comprising the following successive steps:
providing a wort having a gravity of 4.5 to 20° P;
treating the wort with a ZSM-5 zeolite for at least 15 minutes, said ZSM-5 zeolite having has a molar ratio SiO₂/Al₂O₃ of at least 1,000;
separating the treated wort from the ZSM-5 zeolite;
fermenting the treated wort with yeast to produce fermented wort having an alcohol content of at least 1% ABV; and
separating yeast from the fermented wort.

11. Method according to claim 10, wherein the wort is contacted with ZSM-5 zeolite by combining 100 parts by weight of wort with at least 1 part by weight of ZSM-5 zeolite.

12. Method according to claim 10, wherein the treated wort is fermented with a bottom-fermenting yeast.

13. Method according to claim 10, wherein the wort has a temperature in the range of 2 to 50° C. when it is contacted with the ZSM-5 zeolite.

14. Method according to claim 10, wherein the ZSM-5 zeolite has a surface area of at least 100 m²/g.
